(19) United States
(12) Patent Application Publication
(10) Pub. No.: US 2026/0280416 A1
(43) Pub. Date: Sep. 17, 2026

(54) POWER CONVERSION DEVICE, OVERCURRENT DETECTION CIRCUIT, AND SEMICONDUCTOR MODULE

(71) Applicant: Minebea Power Semiconductor Device Inc., Ibaraki (JP)

(72) Inventors: Akira MIMA, Tokyo (JP); Akitoyo KONNO, Hitachi-shi (JP); Taiga ARAI, Hitachi-shi (JP); Daisuke MATSUMOTO, Tokyo (JP)

(21) Appl. No.: 19/471,433

(22) PCT Filed: Feb. 1, 2024
(86) PCT No.: PCT/JP2024/003221

§ 371 Date: Oct. 1, 2025

(30) Foreign Application Priority Data
Apr. 4, 2023 (JP) 2023-060589

(51) Int. Cl. H02M 1/32; H02M 1/00

(52) U.S. Cl. CPC H02M 1/32; H02M 1/0009

(57) ABSTRACT

A power conversion device capable of detecting a load short circuit at high accuracy with a simple circuit configuration comprises an upper-arm switching element, a lower-arm switching element, a high potential-side terminal P, a low potential-side terminal N, an output terminal AC, a first detecting terminal, a second detecting terminal, a high potential-side detection inductance Ldp electromagnetically coupled to a high potential-side wiring inductance Lp between the high potential-side terminal P and the upper-arm switching element, an output-side detection inductance Ldac electromagnetically coupled to an output-side wiring inductance Lac between an upper-lower arm connection node and the output terminal AC, and an overcurrent detection unit that detects an overcurrent based on a potential difference between the first detecting terminal and the second detecting terminal. The high potential-side detection inductance Ldp and the output-side detection inductance Ldac are connected in series between the first and second detecting terminals.

### TECHNICAL FIELD

The present invention relates to a power conversion device, an overcurrent detection circuit, and a semiconductor module.

### BACKGROUND ART

Power conversion devices have a function of converting direct current power supplied from a direct current power source into alternating current power to be supplied to alternating current electrical loads such as a rotating electrical machine or a function of converting alternating current power generated by a rotating electrical machine into direct current power to be supplied to a direct current power source. In order to achieve the power conversion function, power conversion devices have a power conversion circuit having a switching element constituted of a power semiconductor and perform power conversion from direct current power to alternating current power or from alternating current power to direct current power by having the switching element repeatedly perform conductive operations and interrupt operations.

In the power conversion circuit, two switching elements are connected in series and connected to a direct current power source. The switching element connected to a high potential side of the direct current power source is referred to as an upper arm and the switching element connected to a low potential side of the direct current power source is referred to as a lower arm. In addition, an output terminal is connected to an upper-lower arm connection node between the upper-arm switching element and the lower-arm switching element. Alternating current power can be extracted from the output terminal by having the upper-arm switching element and the lower-arm switching element alternately and repeatedly switch on and off.

Here, in a power conversion circuit constituted of a plurality of switching elements, if one switching element is destroyed due to gate noise or end of element life during operation, an excessive short-circuit current flows from the high-potential side of the direct current power source toward the destroyed switching element. In order to prevent the flow of the short-circuit current from destroying even the normal switching element and thereby destroying the entire power conversion device, an overcurrent detection circuit is used to detect the short-circuit current and generate a protection signal that turns off the normal switching element.

In addition, there are two modes of short circuits: a mode referred to as an arm short circuit in which a short circuit occurs between the upper and lower arms of the power conversion circuit and a large current flows; and a mode referred to as a load short circuit in which a large current flows to outside of the power conversion circuit through the output terminal between the upper and lower arms. A load short circuit is generally caused by a ground fault in wiring between the power conversion circuit and the load. Even in the case of a load short circuit, since a large current flows through the switching elements, it is necessary to detect the short circuit and protect the switching elements.

While an arm short circuit is caused by the destruction of a switching element, switching elements in a load short circuit are still intact and the load short circuit is caused by the destruction of the load connected to the power conversion device. Therefore, detecting a load short circuit and protecting switching elements is significant.

For example, Patent Literature 1 is known as a method of detecting an arm short circuit and a load short circuit. A second embodiment (FIG. 10, FIG. 11, and paragraphs 0029 to 0038) of Patent Literature 1 describes a method of detecting di/dt that is a rate of change over time of a current flowing through an emitter of an IGBT, and after a mask period elapses, determining that an arm short circuit has occurred if di/dt exceeds a first threshold but determining that a load short circuit has occurred if di/dt does not exceed the first threshold but exceeds a second threshold. Note that the reason for providing the mask period is to avoid detecting a steep current with a large peak value that appears immediately after gate-on, as described in FIG. 5 and paragraphs 0023 and 0027 of Patent Literature 1.

### CITATION LIST

### Patent Literature

Patent Literature 1: WO 2018/193527

### SUMMARY OF INVENTION

### Technical Problem

However, the method described in Patent Literature 1 has a problem in that detecting a load short circuit requires a mask period for avoiding detection of a peak current that occurs during normal switching to be set and a second threshold for detecting the load short circuit, thereby making the circuit complicated.

An object to be achieved by the present invention is to provide a power conversion device, an overcurrent detection circuit, and a semiconductor module capable of detecting even a load short circuit at high accuracy with a simple circuit configuration.

### Solution to Problem

In order to solve the problem described above, a power conversion device according to the present invention includes: an upper-arm switching element; a lower-arm switching element connected in series to the upper-arm switching element; a high potential-side terminal connected to the upper-arm switching element; a low potential-side terminal connected to the lower-arm switching element; an output terminal connected to an upper-lower arm connection node between the upper-arm switching element and the lower-arm switching element; a first detecting terminal; a second detecting terminal; a high potential-side detection inductance electromagnetically coupled to a high potential-side wiring inductance between the high potential-side terminal and the upper-arm switching element; an output-side detection inductance electromagnetically coupled to an output-side wiring inductance between the upper-lower arm connection node and the output terminal; and an overcurrent detection unit which detects an overcurrent based on a potential difference between the first detecting terminal and the second detecting terminal, wherein the high potential-side detection inductance and the output-side detection inductance are connected in series between the first detecting terminal and the second detecting terminal.

In addition, an overcurrent detection circuit according to the present invention is an overcurrent detection circuit which detects an overcurrent flowing in a power conversion circuit in which an upper-arm switching element and a lower-arm switching element are connected in series between a high potential-side terminal and a low potential-side terminal and an output terminal is connected to an upper-lower arm connection node between the upper-arm switching element and the lower-arm switching element, the overcurrent detection circuit including: a first detecting terminal; a second detecting terminal; a high potential-side detection inductance electromagnetically coupled to a high potential-side wiring inductance between the high potential-side terminal and the upper-arm switching element; an output-side detection inductance electromagnetically coupled to an output-side wiring inductance between the upper-lower arm connection node and the output terminal; and an overcurrent detection unit which detects an overcurrent based on a potential difference between the first detecting terminal and the second detecting terminal, wherein the high potential-side detection inductance and the output-side detection inductance are connected in series between the first detecting terminal and the second detecting terminal.

Furthermore, a semiconductor module according to the present invention includes: an upper-arm switching element; a lower-arm switching element connected in series to the upper-arm switching element; a high potential-side terminal connected to the upper-arm switching element; a low potential-side terminal connected to the lower-arm switching element; an output terminal connected to an upper-lower arm connection node between the upper-arm switching element and the lower-arm switching element; a first detecting terminal; a second detecting terminal; a high potential-side detection inductance electromagnetically coupled to a high potential-side wiring inductance between the high potential-side terminal and the upper-arm switching element; and an output-side detection inductance electromagnetically coupled to an output-side wiring inductance between the upper-lower arm connection node and the output terminal, wherein the high potential-side detection inductance and the output-side detection inductance are connected in series between the first detecting terminal and the second detecting terminal.

### Advantageous Effects of Invention

According to the present invention, even a load short circuit can be detected at high accuracy with a simple circuit configuration.

### BRIEF DESCRIPTION OF DRAWINGS

FIG. 1 is a circuit diagram showing circuit configurations of a power conversion device and an overcurrent detection circuit according to a first embodiment.

FIG. 2 is a circuit diagram showing an example of an overcurrent detection method according to a comparative example.

FIG. 3 is a conceptual diagram of detected voltage in the overcurrent detection method according to the comparative example.

FIG. 4 is a conceptual diagram of detected voltage according to the first embodiment.

FIG. 5 is a circuit diagram showing circuit configurations of a power conversion device and an overcurrent detection circuit according to a second embodiment.

FIG. 6 is a circuit diagram showing a circuit configuration of a power conversion device according to a third embodiment.

FIG. 7 is a circuit diagram showing a circuit configuration of a power conversion device according to a fourth embodiment.

FIG. 8 is a top view and a side view showing configurations of a semiconductor module and an overcurrent detection circuit according to a fifth embodiment.

FIG. 9 is a top view and a side view showing configurations of a semiconductor module and an overcurrent detection circuit according to a sixth embodiment.

FIG. 10 is a top view and a side view showing a configuration of a power conversion device according to a seventh embodiment.

### DESCRIPTION OF EMBODIMENTS

Hereinafter, embodiments of the present invention will be described with reference to the drawings. In each drawing and in each embodiment, same or similar components will be denoted by same reference signs and redundant descriptions will not be repeated.

### First Embodiment

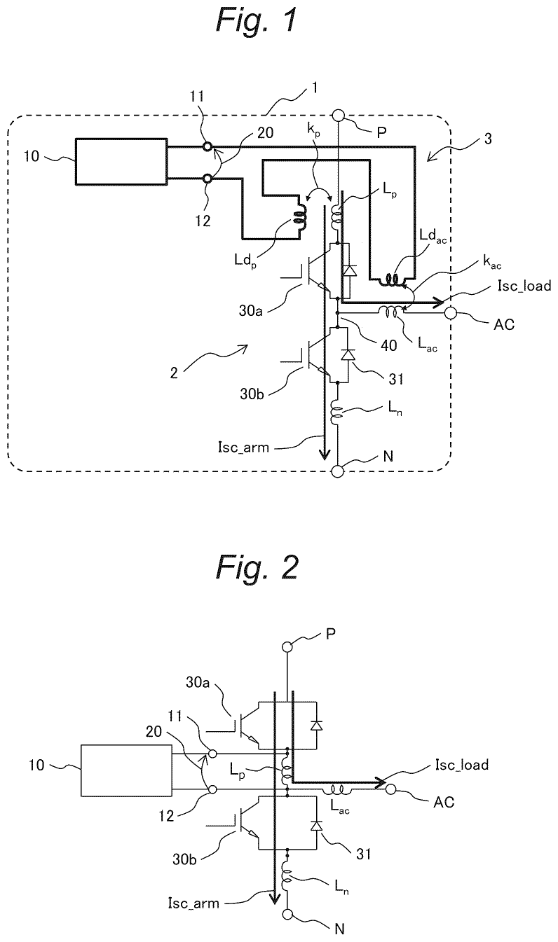

FIG. 1 is a circuit diagram showing circuit configurations of a power conversion device and an overcurrent detection circuit according to a first embodiment.

A power conversion device 1 according to the first embodiment has a power conversion circuit 2 and an overcurrent detection circuit 3.

The power conversion circuit 2 has an upper-arm switching element 30a, a lower-arm switching element 30b connected in series to the upper-arm switching element 30a, a high potential-side terminal P connected to the upper-arm switching element 30a, a low potential-side terminal N connected to the lower-arm switching element 30b, and an output terminal AC connected to an upper-lower arm connection node 40 between the upper-arm switching element 30a and the lower-arm switching element 30b. In other words, the power conversion circuit 2 is configured such that the upper-arm switching element 30a and the lower-arm switching element 30b are connected in series between the high potential-side terminal P and the low potential-side terminal N and the output terminal AC is connected to the upper-lower arm connection node between the upper-arm switching element 30a and the lower-arm switching element 30b.

Here, for example, an Insulated Gate Bipolar Transistor (IGBT) can be used as the upper-arm switching element 30a and the lower-arm switching element 30b. In this case, the power conversion circuit 2 has diodes 31 connected in antiparallel to the upper-arm switching element 30a and the lower-arm switching element 30b, respectively. Note that the upper-arm switching element 30a and the lower-arm switching element 30b are not limited to IGBTs and other switching elements such as Metal Oxide Semiconductor Field Effect Transistors (MOSFETs) may be used instead. When using MOSFETs, body diodes built into the MOSFETs can be used as the diodes 31.

When using IGBTs as the upper-arm switching element 30a and the lower-arm switching element 30b, a collector electrode that is one of main electrodes of the upper-arm switching element 30a is connected to the high potential-side terminal P, an emitter electrode that is the other main electrode of the upper-arm switching element 30a and a collector electrode that is one of main electrodes of the lower-arm switching element 30b are connected to each other, and an emitter electrode that is the other main electrode of the lower-arm switching element 30b is connected to the low potential-side terminal N. Note that in the case of MOSFETS, the term “collector” need only be replaced with “drain” and “emitter” with “source”.

The power conversion circuit 2 has a high potential-side wiring inductance Lp between the high potential-side terminal P and the upper-arm switching element 30a, an output-side wiring inductance Lac between the upper-lower arm connection node 40 and the output terminal AC, and a low potential-side wiring inductance Ln between the lower-arm switching element 30b and the low potential-side terminal N.

Here, the overcurrent detection circuit 3 according to the present embodiment has a first detecting terminal 11, a second detecting terminal 12, an overcurrent detection unit 10 that detects an overcurrent based on a potential difference between the first detecting terminal 11 and the second detecting terminal 12, a high potential-side detection inductance Ldp arranged in proximity to and electromagnetically coupled to the high potential-side wiring inductance Lp, and an output-side detection inductance Ldac arranged in proximity to and electromagnetically coupled to the output-side wiring inductance Lac. In addition, the overcurrent detection circuit 3 according to the present embodiment is configured such that the high potential-side detection inductance Ldp and the output-side detection inductance Ldac are connected in series between the first detecting terminal 11 and the second detecting terminal 12.

During an arm short circuit, an arm short-circuit current Isc_arm flows from the high potential-side terminal P to the high potential-side wiring inductance Lp, the upper-arm switching element 30a, the lower-arm switching element 30b, the low potential-side wiring inductance Ln, and the low potential-side terminal N, in this order.

At this point, an electromotive force is generated in the high potential-side wiring inductance Lp due to the flowing of the arm short-circuit current Isc_arm. On the other hand, the high potential-side detection inductance Ldp and the high potential-side wiring inductance Lp are electromagnetically coupled by a coupling coefficient kp and an electromotive force 20 is generated between the first detecting terminal 11 and the second detecting terminal 12. Vdidt_arm that is a voltage of the electromotive force 20 can be expressed as in equation (1).

$$\begin{matrix}[ Math . 1 ] & \\ {V}_{didt \_ arm} = {k}_{p} * \sqrt{( {L}_{dp} * {L}_{p} )} * {dI}_{sc \_ arm} / dt & ( 1 )\end{matrix}$$

During a load short circuit, a load short-circuit current Isc_load flows from the high potential-side terminal P to the high potential-side wiring inductance Lp, the upper-arm switching element 30a, the output-side wiring inductance Lac, and the output terminal AC, in this order.

At this point, since the electromotive force 20 generated between the first detecting terminal 11 and the second detecting terminal 12 is a sum of an electromotive force generated by the high-potential-side detection inductance Ldp and an electromotive force generated by the output-side detection inductance Ldac that is electromagnetically coupled to the output-side wiring inductance Lac with a coupling coefficient kac, Vdidt_load that is a voltage of the electromotive force 20 can be expressed as in equation (2).

$$\begin{matrix}[ Math . 2 ] & \\ {V}_{didt \_ load} = ( {k}_{p} * \sqrt{( {L}_{dp} * {L}_{p} )} + {k}_{ac} * \sqrt{( {L}_{dac} * {L}_{ac} )} ) * {dI}_{sc \_ load} / dt & ( 2 )\end{matrix}$$

The overcurrent detection unit 10 detects the electromotive force 20, and when the electromotive force 20 exceeds a predetermined threshold, the overcurrent detection unit 10 determines that a short-circuit current has flowed and stops the operation of the power conversion circuit 2. According to the configuration of the present embodiment, by adjusting magnitudes of the coupling coefficient kac, the output-side wiring inductance Lac, and the output-side detection inductance Ldac in equation (2), detection sensitivity can be adjusted. Therefore, even a load short circuit can be detected at high accuracy.

As described above, according to the present invention, even a load short circuit can be detected at high accuracy with a simple circuit configuration.

FIG. 2 is a circuit diagram showing an example of an overcurrent detection method according to a comparative example.

In the overcurrent detection method according to the comparative example shown in FIG. 2, an overcurrent is detected using the high potential-side wiring inductance Lp, and unlike the first embodiment, the high potential-side detection inductance Ldp and the output-side detection inductance Ldac are not provided.

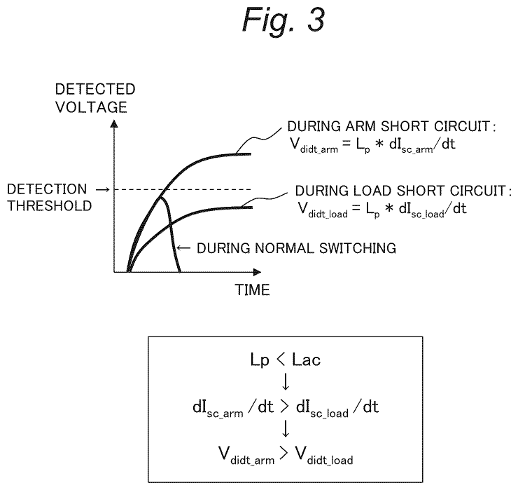

FIG. 3 is a conceptual diagram of detected voltage in the overcurrent detection method according to the comparative example. In FIG. 3, an axis of ordinate indicates detected voltage and an axis of abscissa indicates time.

In the overcurrent detection method according to the comparative example, Vdidt_arm that is a voltage of the electromotive force 20 that can be detected during an arm short circuit can be expressed as in equation (3).

$$\begin{matrix}[ Math . 3 ] & \\ {V}_{didt \_ arm} = {L}_{p} * {dI}_{sc \_ arm} / dt & ( 3 )\end{matrix}$$

On the other hand, Vdidt_load that is a voltage of the electromotive force 20 that can be detected during a load short circuit can be expressed as in equation (4).

$$\begin{matrix}[ Math . 4 ] & \\ {V}_{didt \_ load} = {L}_{p} * {dI}_{sc \_ load} / dt & ( 4 )\end{matrix}$$

Normally, the power conversion circuit 2 lowers the high potential-side wiring inductance Lp in order to suppress voltage spikes during operation. On the other hand, reducing the output-side wiring inductance Lac need not be considered and Lp<Lac is satisfied.

In this case, if the value of the output-side wiring inductance Lac is large, a current will flow less easily and a current slope will become smaller. Therefore, since comparing the slopes of the arm short-circuit current Isc_arm and the load short-circuit current Isc_load during an occurrence of short circuits reveals that dIsc_arm/dt>dIsc_load/dt, according to equations (3) and (4), comparing Vdidt_arm of the electromotive force 20 detectable during an arm short circuit and Vdidt_load of the electromotive force 20 detectable during a load short circuit reveals that Vdidt_arm>Vdidt_load. Therefore, Vdidt_load of the electromotive force 20 that is generated during a load short circuit becomes smaller than a detection threshold provided in order to detect an arm short circuit, making it impossible to detect a load short-circuit current. Since setting the detection threshold lower than Vdidt_load makes it indistinguishable from a detected voltage generated during normal switching, the detection threshold cannot be set lower than the detected voltage generated during normal switching.

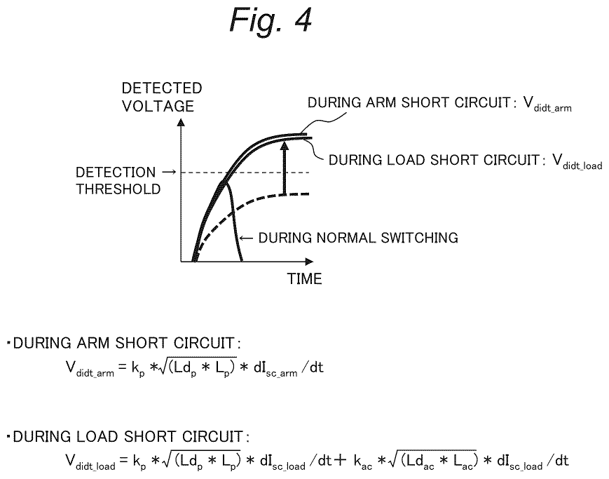

FIG. 4 is a conceptual diagram of detected voltage according to the first embodiment. In FIG. 4, an axis of ordinate indicates detected voltage and an axis of abscissa indicates time.

In the method according to the present embodiment, Vdidt_arm of the electromotive force 20 during an arm short circuit is as shown in equation (1), and the detected voltage can be changed by the values of the electromagnetically coupled high potential-side detection inductance Ldp and the coupling coefficient kp.

In addition, during a load short circuit, when the slope of the load short-circuit current Isc_load during a load short circuit becomes smaller as expressed by dIsc_arm/dt>dIsc_load/dt, since an electromotive force generated by the output-side detection inductance Ldac electromagnetically coupled to the output-side wiring inductance Lac and the coupling coefficient kac is also added, a detectable electromotive force becomes larger as compared to the comparative example in FIG. 2 and FIG. 3, and by setting Vdidt_load during a load short circuit to a same level as Vdidt_arm during an arm short circuit, it is possible to obtain a detected voltage equal to or exceeding the detection threshold voltage in a similar manner to during an arm short circuit. Accordingly, even a short-circuit current during a load short circuit can be detected.

### Second Embodiment

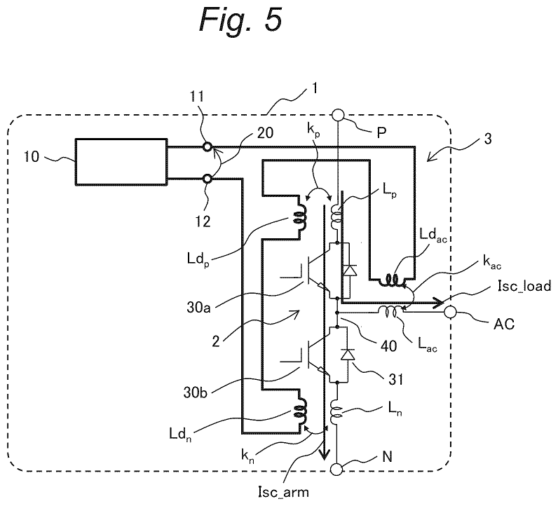

FIG. 5 is a circuit diagram showing circuit configurations of a power conversion device and an overcurrent detection circuit according to a second embodiment.

The second embodiment is a modification of the first embodiment and differs from the first embodiment in that the second embodiment has a low potential-side detection inductance Ldn.

In addition to the components of the first embodiment, the overcurrent detection circuit 3 according to the present embodiment has the low potential-side detection inductance Ldn electromagnetically coupled to the low potential-side wiring inductance Ln. Here, a coupling coefficient of the low potential-side detection inductance Ldn and the low potential-side wiring inductance Ln is kn.

In addition, the low potential-side detection inductance Ldn is structurally connected in series with the high potential-side detection inductance Ldp and the output-side detection inductance Ldac.

According to the present embodiment, since an electromotive force due to the low potential-side detection inductance Ldn also becomes a detectable voltage in addition to an electromotive force due to the high potential-side detection inductance Ldp during an arm short circuit, detection sensitivity during an arm short circuit can be increased.

### Third Embodiment

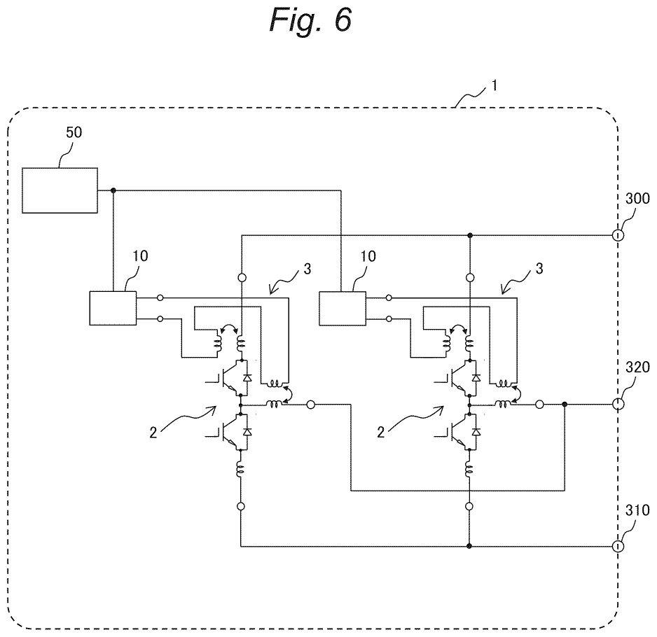

FIG. 6 is a circuit diagram showing a circuit configuration of a power conversion device according to a third embodiment.

The third embodiment is a modification of the first embodiment and differs from the first embodiment in that two power conversion circuits 2 are connected in parallel.

In the power conversion device 1 according to the present embodiment, two power conversion circuits 2 described in the first embodiment are connected in parallel and have a common high potential-side terminal 300, a common low potential-side terminal 310, and a common output terminal 320. Accordingly, higher output can be produced.

In the power conversion device 1 according to the present embodiment, the overcurrent detection circuit 3 is provided so as to correspond to each of the power conversion circuits 2 connected in parallel, and each overcurrent detection unit 10 is connected to a common higher-level control circuit 50.

The present embodiment adopts a configuration capable of detecting a short-circuit current if the short-circuit current is generated in at least one power conversion circuit 2 among the power conversion circuits 2 connected in parallel. Information on the detection of a short circuit is transmitted to the higher-level control circuit 50, and the higher-level control circuit 50 can determine that a short circuit has occurred and stop the operation of the power conversion circuit 2.

Furthermore, in the case of a configuration in which the power conversion circuit 2 is connected in parallel, there is a problem in that when one switching element of one of the upper and lower arms is destroyed, a short-circuit current is shared by the parallel-connected switching element of the opposite arm (the other arm of the upper and lower arms), possibly reducing sensitivity of short-circuit detection.

According to the power conversion device 1 and the overcurrent detection circuit 3 of the present embodiment, since a detected voltage can be changed by values of the high potential-side detection inductance Ldp and the coupling coefficient kp as described in the first embodiment, this problem can be solved by appropriately adjusting the sensitivity.

### Fourth Embodiment

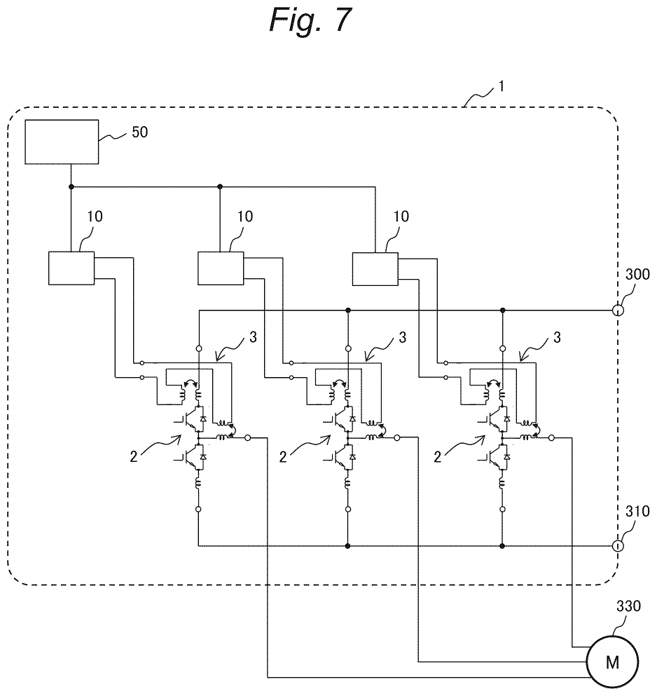

FIG. 7 is a circuit diagram showing a circuit configuration of a power conversion device according to a fourth embodiment.

The fourth embodiment is a modification of the first embodiment and differs from the first embodiment in that the power conversion circuit 2 of the power conversion device 1 has a three-phase configuration.

In the power conversion device 1 according to the present embodiment, a three-phase configuration is adopted in which three power conversion circuits 2 are connected to the common high potential-side terminal 300 and the common low potential-side terminal 310, and the output terminal of each power conversion circuit 2 is connected to a corresponding phase of a three-phase load 330.

In the power conversion device 1 according to the present embodiment, the overcurrent detection circuit 3 is provided so as to correspond to each of the three power conversion circuits 2, and each overcurrent detection unit 10 is connected to the common higher-level control circuit 50.

In the present embodiment, when a short circuit occurs in any of the three power conversion circuits 2, the short circuit can be detected by the corresponding overcurrent detection circuit 3, and even if a load short circuit occurs in the load 330, the load short circuit can be detected by any of the overcurrent detection circuits 3.

### Fifth Embodiment

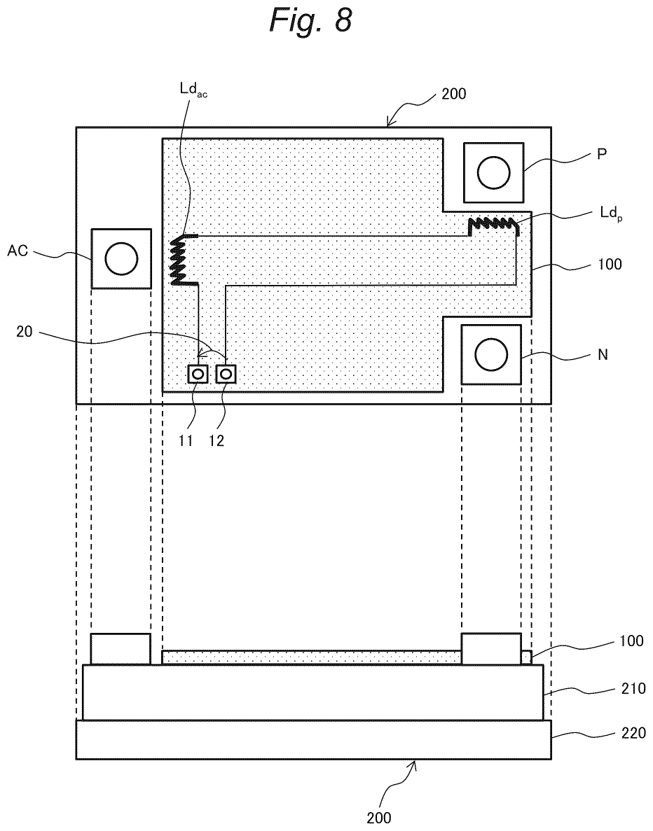

FIG. 8 is a top view and a side view showing configurations of a semiconductor module and an overcurrent detection circuit according to a fifth embodiment.

The fifth embodiment is an embodiment that describes one example of configurations of a semiconductor module 200 and the overcurrent detection circuit 3 that can be used in FIG. 1 of the first embodiment.

The semiconductor module 200 according to the present embodiment has the power conversion circuit 2 described in FIG. 1 of the first embodiment, a case 210, and a heat dissipation base 220. Here, most of the components of the power conversion circuit 2 including the upper-arm switching element 30a and the lower-arm switching element 30b are housed inside the case 210. The high potential-side terminal P, the low potential-side terminal N, and the output terminal AC among the components of the power conversion circuit 2 are provided outside the case 210 as external main terminals. In addition, in the semiconductor module 200, external auxiliary terminals (not illustrated) such as a gate terminal for driving the upper-arm switching element 30a and the lower-arm switching element 30b are also provided outside of the case 210.

When using the semiconductor module 200 configured as described above, a circuit board 100 is connected to the outside of the case 210.

The first detecting terminal 11, the second detecting terminal 12, the high potential-side detection inductance Ldp, and the output-side detection inductance Ldac are provided on the circuit board 100 of the present embodiment. The circuit board 100 is structured to be mounted on an upper surface of the case 210, and by arranging the high potential-side detection inductance Ldp in proximity to the high potential-side terminal P and arranging the output-side detection inductance Ldac in proximity to the output terminal AC, the high potential-side detection inductance Ldp and the output-side detection inductance Ldac can be electromagnetically coupled to the high potential-side wiring inductance Lp and the output-side wiring inductance Lac, respectively.

The high potential-side detection inductance Ldp and the output-side detection inductance Ldac are connected in series between the first detecting terminal 11 and the second detecting terminal 12 and can connect the overcurrent detection unit 10 with the first detecting terminal 11 and the second detecting terminal 12.

A drive circuit (not illustrated) for driving the upper-arm switching element 30a and the lower-arm switching element 30b may be mounted on the circuit board 100. Note that the drive circuit is not limited thereto and may be provided outside the circuit board 100. In addition, the overcurrent detection unit 10 may also be mounted on the circuit board 100 or provided outside the circuit board 100.

In addition, as a modification of the fifth embodiment, the semiconductor module 200 may have the high potential-side detection inductance Ldp and the output-side detection inductance Ldac to be housed inside the case 210. In this case, the high potential-side detection inductance Ldp and the output-side detection inductance Ldac can be mounted on a substrate (not illustrated) housed inside the case 210. Furthermore, the semiconductor module 200 may have the first detecting terminal 11 and the second detecting terminal 12 outside the case 210 as parts of external auxiliary terminals.

### Sixth Embodiment

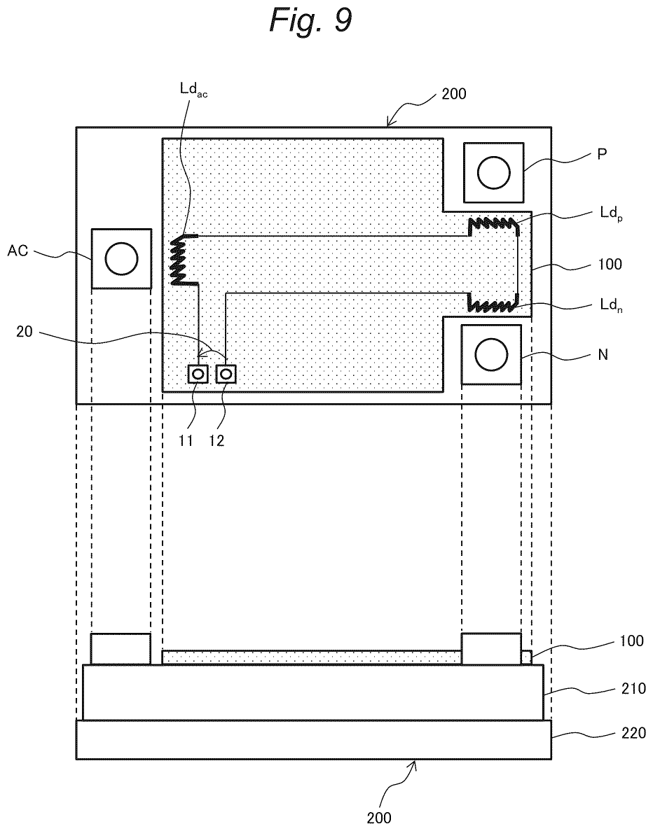

FIG. 9 is a top view and a side view showing configurations of a semiconductor module and an overcurrent detection circuit according to a sixth embodiment.

The sixth embodiment is an embodiment that describes one example of configurations of the semiconductor module 200 and the overcurrent detection circuit 3 that can be used in FIG. 5 of the second embodiment.

The present embodiment differs from the fifth embodiment in that the present embodiment has the low potential-side detection inductance Ldn.

The configuration of the semiconductor module 200 according to the present embodiment is the same as in the fifth embodiment.

In the present embodiment, the configuration of the overcurrent detection circuit 3 is also approximately the same as in the fifth embodiment, and in addition to the configuration of the fifth embodiment, the low potential-side detection inductance Ldn is also mounted on the circuit board 100 and connected in series with the high potential-side detection inductance Ldp and the output-side detection inductance Ldac. The low potential-side detection inductance Ldn is arranged in proximity to the low potential-side terminal N and electromagnetically coupled to the low potential-side wiring inductance Ln.

Other components are the same as in the fifth embodiment.

In addition, as a modification of the sixth embodiment, the semiconductor module 200 may have the high potential-side detection inductance Ldp, the output-side detection inductance Ldac, and the low potential-side detection inductance Ldn to be housed inside the case 210 in a similar manner to the modification of the fifth embodiment.

### Seventh Embodiment

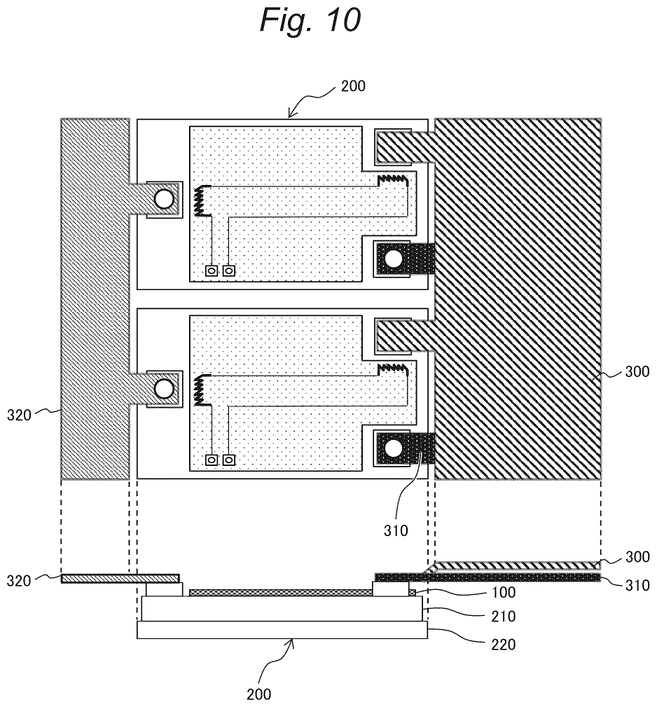

FIG. 10 is a top view and a side view showing a configuration of a power conversion device according to a seventh embodiment.

The seventh embodiment is an embodiment for describing an example of realizing the configuration in FIG. 6 of the third embodiment using the semiconductor module 200 in FIG. 8 of the fifth embodiment.

The power conversion device 1 according to the present embodiment has two semiconductor modules 200 connected in parallel, the high potential-side terminal P is connected to the common high potential-side terminal 300, the low potential-side terminal N is connected to the common low potential-side terminal 310, and the output terminal AC is connected to the common output terminal 320, respectively.

The common high potential-side terminal 300 and the common low potential-side terminal 310 can use, for example, a laminated structure arranged in layers as shown in FIG. 10. Adopting such a structure enables wiring inductance to be reduced.

In addition, as a modification of the seventh embodiment, when realizing the configuration in FIG. 7 of the fourth embodiment, the power conversion device 1 may be configured to have three semiconductor modules 200, the common high potential-side terminal 300, and the common low potential-side terminal 310. Note that since the fourth embodiment has three phases, each output terminal AC need only be connected to a corresponding phase of the load 330 instead of using the common output terminal 320.

While embodiments of the present invention have been described above, it is to be understood that the present invention is not limited to the configurations described in the embodiments and various modifications can be made within the scope of technical concepts of the invention. In addition, some or all of the configurations described in each embodiment may also be applied in combination.

### REFERENCE SIGNS LIST

1 Power conversion device
2 Power conversion circuit
3 Overcurrent detection circuit
10 Overcurrent detection unit
11 First detecting terminal
12 Second detecting terminal
20 Electromotive force
30a Upper-arm switching element
30b Lower-arm switching element
31 Diode
40 Upper-lower arm connection node
50 Higher-level control circuit
100 Circuit board
200 Semiconductor module
210 Case
220 Heat dissipation base
300 Common high potential-side terminal
310 Common low potential-side terminal
320 Common output terminal
330 Load
P High potential-side terminal
N Low potential-side terminal
AC Output terminal
Lp High potential-side wiring inductance
Ln Low potential-side wiring inductance
Lac Output-side wiring inductance
Ldp High potential-side detection inductance
Ldn Low potential-side detection inductance
Ldac Output-side detection inductance
Isc_arm Arm short-circuit current
Isc_load Load short-circuit current

1. A power conversion device, comprising:
an upper-arm switching element;
a lower-arm switching element connected in series to the upper-arm switching element;
a high potential-side terminal connected to the upper-arm switching element;
a low potential-side terminal connected to the lower-arm switching element;
an output terminal connected to an upper-lower arm connection node between the upper-arm switching element and the lower-arm switching element;
a first detecting terminal;
a second detecting terminal;
a high potential-side detection inductance electromagnetically coupled to a high potential-side wiring inductance between the high potential-side terminal and the upper-arm switching element;
an output-side detection inductance electromagnetically coupled to an output-side wiring inductance between the upper-lower arm connection node and the output terminal; and
an overcurrent detection unit that detects an overcurrent based on a potential difference between the first detecting terminal and the second detecting terminal, wherein
the high potential-side detection inductance and the output-side detection inductance are connected in series between the first detecting terminal and the second detecting terminal.

2. The power conversion device according to claim 1, comprising
a low potential-side detection inductance electromagnetically coupled to a low potential-side wiring inductance between the low potential-side terminal and the lower-arm switching element, wherein
the high potential-side detection inductance, the output-side detection inductance, and the low potential-side detection inductance are connected in series between the first detecting terminal and the second detecting terminal.

3. The power conversion device according to claim 1, comprising
a case which internally houses the upper-arm switching element and the lower-arm switching element; and
a circuit board which is arranged outside of the case and on which the first detecting terminal, the second detecting terminal, the high potential-side detection inductance, and the output-side detection inductance are provided.

4. An overcurrent detection circuit which detects an overcurrent flowing in a power conversion circuit in which an upper-arm switching element and a lower-arm switching element are connected in series between a high potential-side terminal and a low potential-side terminal and an output terminal is connected to an upper-lower arm connection node between the upper-arm switching element and the lower-arm switching element, the overcurrent detection circuit comprising:
a first detecting terminal;
a second detecting terminal;
a high potential-side detection inductance electromagnetically coupled to a high potential-side wiring inductance between the high potential-side terminal and the upper-arm switching element;
an output-side detection inductance electromagnetically coupled to an output-side wiring inductance between the upper-lower arm connection node and the output terminal; and
an overcurrent detection unit that detects an overcurrent based on a potential difference between the first detecting terminal and the second detecting terminal, wherein
the high potential-side detection inductance and the output-side detection inductance are connected in series between the first detecting terminal and the second detecting terminal.

5. The overcurrent detection circuit according to claim 4, comprising
a low potential-side detection inductance electromagnetically coupled to a low potential-side wiring inductance between the low potential-side terminal and the lower-arm switching element, wherein
the high potential-side detection inductance, the output-side detection inductance, and the low potential-side detection inductance are connected in series between the first detecting terminal and the second detecting terminal.

6. A semiconductor module, comprising:
an upper-arm switching element;
a lower-arm switching element connected in series to the upper-arm switching element;
a high potential-side terminal connected to the upper-arm switching element;
a low potential-side terminal connected to the lower-arm switching element;
an output terminal connected to an upper-lower arm connection node between the upper-arm switching element and the lower-arm switching element;
a first detecting terminal;
a second detecting terminal;
a high potential-side detection inductance electromagnetically coupled to a high potential-side wiring inductance between the high potential-side terminal and the upper-arm switching element; and
an output-side detection inductance electromagnetically coupled to an output-side wiring inductance between the upper-lower arm connection node and the output terminal, wherein
the high potential-side detection inductance and the output-side detection inductance are connected in series between the first detecting terminal and the second detecting terminal.

7. The semiconductor module according to claim 6, comprising
a low potential-side detection inductance electromagnetically coupled to a low potential-side wiring inductance between the low potential-side terminal and the lower-arm switching element, wherein
the high potential-side detection inductance, the output-side detection inductance, and the low potential-side detection inductance are connected in series between the first detecting terminal and the second detecting terminal.

8. The semiconductor module according to claim 6, comprising
a case which internally houses the upper-arm switching element, the lower-arm switching element, the high potential-side detection inductance, and the output-side detection inductance.
